(19) United States
(12) Patent Application Publication
(10) Pub. No.: US 2025/0244503 A1
(43) Pub. Date: Jul. 31, 2025

(54) COMPUTER-IMPLEMENTED METHOD FOR OPTIMIZATION OF OIL FIELD DRAINAGE NETWORK

(71) Applicants: PETRÓLEO BRASILEIRO S.A. – PETROBRAS, Rio de Janeiro (BR); PONTIFÍCIA UNIVERSIDADE CATÓLICA DO RIO DE JANEIRO, Rio de Janeiro (BR)

(72) Inventors: Marco Antonio CARDOSO, Rio de Janeiro (BR); Manuel Parcero OLIVEIRA, Rio de Janeiro (BR); Marco Aurélio CAVALCANTI PACHECO, Rio de Janeiro (BR); Bruno Fidalgo Telles RODRIGUES, Rio de Janeiro (BR); Flavia De Oliveira Lima FALCAO, Rio de Janeiro (BR); Flank Melo DE LIMA, Macaé (BR); Ana Carolina ALVES ABREU, Rio de Janeiro (BR); Paulo Roberto EVELIM BORGES, Rio de Janeiro (BR)

(21) Appl. No.: 19/017,725

(22) Filed: Jan. 12, 2025

(30) Foreign Application Priority Data
Jan. 31, 2024 (BR) 1020240020294

(51) Int. Cl. G01V 20/00

(52) U.S. Cl. CPC G01V 20/00

(57) ABSTRACT

The present disclosure discloses embodiments of methods for well trajectory optimization. Data from 2D and/or 3D maps representative of geohazards located above a reservoir are considered during the simulation instead of raw geohazard data. This allows great optimization in the simulation processing time. Furthermore, an interactive well trajectory simulation process is performed based on the data from the 2D and/or 3D maps representative of the geohazards.

### FIELD OF THE DISCLOSURE

The present disclosure falls within the field of reservoir engineering. More specifically, the present disclosure is related to a computer-implemented method optimized for generating a drainage network for an oil field.

### BACKGROUND OF THE DISCLOSURE

Optimizing the drainage network for an oil and gas producing field is an extremely time-consuming and complex process, requiring a specialized multidisciplinary team to manually determine the quantity and trajectory of the producing and injector wells needed to obtain the best possible drainage network. Since there is a very large number of variables that depend on each other, there is a huge amount of rework until a satisfactory solution is reached, which is not necessarily the best possible.

The reservoir engineering discipline is responsible for developing flow simulation models in oil and/or gas producing reservoirs. These models are built based on a series of information, which includes geological, reservoir engineering and operational data. The construction of these models involves the application of physical and mathematical principles to describe the behavior of fluid flow in the subsurface, aiding in planning and decision-making during hydrocarbon production.

The information required to perform the simulation includes reservoir fluid data, well data, production and injection data, pressure data, petrophysical properties of reservoir rocks, and operational data. Based on this information, reservoir engineers can develop numerical models that represent the reservoir and its physical characteristics. These models are built using discretization techniques in space and time, and the flow equations are solved numerically to simulate the behavior of fluid flow over time. These simulations allow prediction of reservoir performance, evaluation of different production strategies, and aid in decision-making related to hydrocarbon exploration and production.

Reservoir flow simulation is a computationally intensive task and can require significant resources in terms of processing power and data storage. The computational cost of reservoir flow simulation can be affected by several factors, including reservoir size and complexity, model resolution, simulation duration, and desired accuracy. Optimization strategies and advances in computational technology have contributed to mitigating computational cost, allowing for more accurate and efficient simulations.

### STATE OF THE ART

The document from the state of the art WO 2006065915 A2, entitled “Geometrical optimization of multi-well trajectories”, discloses a method for automatically designing a multi-well development plan, given a set of previously interpreted subsurface targets. This method identifies the optimal plan by minimizing the total cost as a function of the existing and required new platforms, the number of wells, and the drilling cost of each well. The cost of each well is a function of the well path and the overall complexity. The technology comprises reservoir simulation and selecting the well locations and their trajectories considering several factors, including geohazards.

The document from the state of the art US2015094994 A1, entitled “Method and System Of Interactive Drill Center and Well Planning Evaluation and Optimization”, discloses a method including: identifying a well target or reservoir segment; defining a dynamic surface grid, the dynamic surface grid being a representation of a ground surface, sea level, or subsea surface above a reservoir on which a drilling center may be located, and the dynamic surface grid includes a plurality of cells that define potential locations for the drilling center; assigning, to each of the plurality of cells of the dynamic surface grid, a value of a drilling or geological attribute that defines a quality of a drilling center position relative to the well target or reservoir segment; and selecting, based on a value of the drilling or geological attribute, a location for the drilling center corresponding to a location represented in the dynamic surface grid.

The document from the state of the art WO 2012027020 A1, entitled “System and method for planning a well path”, discloses a system and method for planning a well path. An exemplary method comprises defining a proxy constraint volume as a three-dimensional (3D) cell volume where each cell has at least one value derived from data from a 3D earth model. An initial well path is defined within user-defined drilling parameter constraints. The exemplary method comprises defining acceptable constraint parameters to be applied to values derived from an intersection of the initial well path and the proxy constraint volume. If the intersection of the initial well path and the proxy constraint volume is not within the acceptable constraint parameters, the initial well path may be iteratively adjusted to create successive well paths until at least one of the successive well paths are within the acceptable constraint parameters for the values derived from the intersection of the well path and the proxy constraint volume.

### SUMMARY OF THE DISCLOSURE

The present disclosure is directed to embodiment of use of 2D and/or 3D map data representative of geohazards as input data in a well trajectory simulation. This data replaces the raw simulation cell data that would be used in a conventional method. This allows for enhanced optimization in the processing and simulation of the trajectory, making it faster to obtain a result.

The present disclosure also provides for the interactive simulation of well trajectories based on the data from the 2D and/or 3D maps. First, starting points are chosen for an optimal trajectory that is simulated, and it is verified whether it meets predetermined requirements, for example, whether it has a geological risk lower than a predetermined risk. If not, new trajectories are simulated with an increase in the horizontal position of the wellhead or in the well angle and it is verified whether at least one of them meets the predetermined requirements. If not, new increments are performed until a satisfactory trajectory or an increment limit is reached. If the increment limit is reached first, the initial points chosen for the well are discarded and new simulations are performed with new initial points.

### BRIEF DESCRIPTION OF THE DRAWINGS

The present disclosure will be described below with reference to its typical embodiments and also with reference to the attached drawings.

FIG. 1 is a schematic representation of the reservoir and of several geological formations above and below the reservoir, according to embodiments of the present disclosure.

FIG. 2 is a representation of the strategy for optimizing the trajectory of the wells considering the limits of maximum distance from the wellhead and the inclination angle, according to embodiments of the present disclosure.

FIG. 3 is a graphical representation of trajectories obtained by the method, according to embodiments of the present disclosure.

FIG. 4 is a representation of general information with the lengths and the x, y and z coordinates of the several phases of the construction process of wells, according to embodiments of the present disclosure.

FIG. 5 is a representation of a 2D geohazard map, according to embodiments of the present disclosure.

FIG. 6 is a representation of the process used to use the data entered through 2D geohazard maps in the drainage network optimization process, according to embodiments of the present disclosure.

FIG. 7 is a representation of a 3D geohazard map according to the present disclosure.

FIG. 8 is a representation of the process used to use the data entered through 3D geohazard maps in the drainage network optimization process, according to the present disclosure.

FIG. 9 is a representation of the type of complexity of 3D mapped data in accordance with embodiments of the present disclosure.

FIG. 10 is a representation of the definition of risk conditions for geohazards mapped, in accordance with embodiments of the present disclosure.

### DETAILED DESCRIPTION OF THE DISCLOSURE

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system-related and business constraints, which may vary from one implementation to another. Furthermore, it should be appreciated that such a development effort may be complex and time-consuming but would nevertheless be a routine design project and manufacturing for those of ordinary skill having the benefit of this disclosure.

The drainage network, which consists of the arrangement of producing and injecting wells in an oil and/or gas reservoir, plays a crucial role in maximizing production and economic return in the oil and gas industry. The efficiency and optimization of this arrangement are fundamental to achieving sustainable and profitable production throughout the useful life of the reservoir.

The main objective of a well-designed drainage network is to ensure maximum recovery of the fluids in the reservoir. To achieve this objective, the network must be able to cover all productive areas of the reservoir and allow efficient access to the oil and/or gas volumes. This involves an adequate combination of producing and injecting wells, strategically positioned based on geology, reservoir characteristics and fluid properties.

The drainage network plays a critical role in maximizing production and economic return in the oil and gas industry. A well-designed and optimized network allows maximum recovery of fluids, ensuring production efficiency throughout the useful life of the reservoir. The appropriate combination of production and injection wells, together with the ability to continuously adapt and optimize, is essential to achieve production and economic objectives.

In addition to the above points, consideration of the geological formations above the reservoir is extremely important when defining the drainage network in an oil and/or gas production field. This is due to the possibility of geohazards occurring, which are geological risks that can represent significant restrictions on the construction of wells or require the optimization of the trajectory of wells above the reservoir.

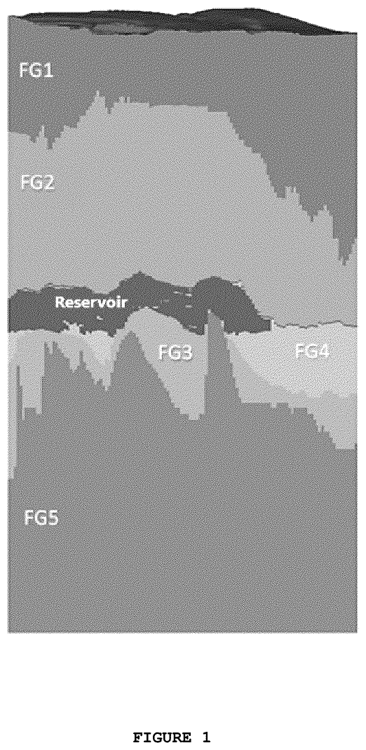

FIG. 1 shows a representation of an offshore production system in which it can be observed the reservoir and several geological formations, some above the reservoir and others below. The formations above the reservoir are those that directly impact the drilling of wells, and, therefore, are those in which geohazards must be studied.

Geohazards can include a variety of geological phenomena, such as geological faults, high-pressure zones, unstable formations, fractured zones, cavities, seabed slope, ground slope, or other adverse conditions. These risks can negatively affect the drilling and operation of wells, and can lead to problems such as well collapse, loss of drilling fluids, influx of non-productive water, or even environmental disasters.

One of the main restrictions that geohazards can impose is the impossibility of constructing wells in certain areas due to adverse geological conditions. For example, an active geological fault or an unstable formation can pose a significant risk to the safety of drilling and well operations. In such cases, it is necessary to adjust the drainage network, avoiding the location of wells in these high-risk areas.

Furthermore, even when well drilling is possible, geohazards may require optimization of the well path above the reservoir. This means that the well path may need to be planned in a way that minimizes the risks associated with the geological formations above. This optimization may involve drilling oblique sections, diversions, use of directional guidance tools, and other techniques to bypass problem areas and avoid contact with risky geological formations.

Proper consideration of geohazards and optimization of the well path above the reservoir not only helps ensure the safety of operations but can also have significant impacts on production efficiency and maximization of economic return. By avoiding risk areas and optimizing the well path, it is possible to reduce issues such as fluid loss, drilling and operation interruptions, rework, or the need for costly corrective measures. This results in more efficient operation, shorter drilling time, and lower operating costs, increasing productivity and economic return from the field.

Furthermore, understanding geohazards and considering them when defining the drainage network allows for a more integrated and sustainable approach to oil and gas exploration. By minimizing geological risks and avoiding damage to formations above the reservoir, it is possible to preserve the integrity of the upper geological layers, prevent groundwater contamination and reduce negative environmental impacts. Thus, considering the geological formations above the reservoir and identifying geohazards are extremely important when defining the drainage network in an oil and/or gas production field. These geological risks can act as significant constraints on well construction or require optimization of the well trajectory above the reservoir. Properly addressing and mitigating geohazards not only ensures the safety of operations, but also has positive impacts on production efficiency, economic return and the sustainability of natural resource exploration.

However, building a flow simulation model that includes both the reservoir, and the upper geological formations can be computationally extremely expensive due to the extremely high number of cells that need to be simulated. This is due to the complexity and scale of reservoirs, which generally cover a vast area and have different geological formations above the reservoir. In FIG. 1, the regions above the reservoir are represented by the colors green and light blue, and, in general, represent volumes of rock several orders of magnitude larger than the reservoir volume.

To simulate fluid flow in a reservoir, it is necessary to discretize the space into smaller cells or elements to represent the geometry and properties of the subsurface. The more detailed and accurate the model, the smaller the cell size and the greater the total number of cells required. This is especially challenging when considering upper geological formations, as they add an extra dimension to the model, further increasing the number of cells.

The number of cells in a flow simulation model is directly proportional to the number of layers in the vertical direction and the resolution in each horizontal direction. With the inclusion of upper geological formations, the number of cell layers increases, and the discretization in each layer may require a detailed resolution to accurately capture the geological and petrophysical characteristics of these formations.

For example, a reservoir with an area of 10 km by 10 km and a thickness of 200 meters, where the discretization is performed with cells of 100 meters by 100 meters in the horizontal direction and 2 meters in the vertical direction. In this case, the representative model of the reservoir would have 1 million cells. If 2000 meters of upper geological formations were included with the same resolution, we would have 10 million more cells, so that the total number of cells would increase to 11 million cells.

Real reservoirs can have much larger dimensions, with areas of tens or hundreds of square kilometers, in addition to variable thicknesses throughout the reservoir and multiple upper geological formations. This complexity requires a more detailed discretization and results in an exponentially larger number of cells to be simulated.

The large number of cells in a flow simulation model that encompasses the reservoir, and the upper formations results in a significant computational load. However, since in the upper layers, in general, there is no production or injection of fluids, the cost of the dynamic simulation is not directly impacted by the cells in the upper layers. However, there is an increase in the computational cost due to the reading of the input data, since the number of cells in the upper layers can be significantly larger when compared to the number of cells in the reservoir alone. The flow equations must be solved for each cell in each temporal iteration, and this requires substantial processing power. The more cells that are present, the greater the computing time required to complete each simulation. Furthermore, the increase in the number of cells also implies greater data storage requirements. Each cell contains information such as reservoir properties, fluid saturation, pressures, among other data. With a very large number of cells, the amount of information to be stored and processed becomes considerably larger, requiring robust and high-performance data storage systems.

To deal with the computational challenge of flow simulation models with a large number of cells, optimization, parallelization and supercomputer techniques are employed. These approaches aim to reduce simulation time and increase computational efficiency, allowing more detailed and accurate simulations to be performed within a reasonable time.

Therefore, building a flow simulation model that includes the reservoir, and the upper geological formations can be computationally expensive due to the extremely high number of cells that need to be manipulated. The complexity and scale of reservoirs, together with the need to represent the geological characteristics of the upper formations, significantly increase the number of cells, requiring considerable computational resources to perform detailed and accurate simulations.

To deal with the high computational cost associated with including the upper formations in a flow simulation model, the present disclosure adopts the strategy of replacing them with a set of 2D and 3D maps that represent the mapped geohazards. This approach substantially reduces the number of cells to be simulated, bringing the computational cost closer to that equivalent to simulating the reservoir alone. This strategy simplifies the representation of the upper geological formations, maintaining only the essential information for flow simulation and avoiding the need to discretize and simulate each cell individually. Instead, maps are used that indicate the presence and distribution of relevant geohazards, such as faults, high-pressure zones, unstable formations, seabed slope, among others.

To achieve this goal, a computational tool capable of reading and manipulating 2D and 3D geohazard maps was developed. This tool is integrated into commercial flow simulators without limitation, where the data obtained from the 2D and 3D geohazard maps will replace the more complex data from the upper formations. Thus, the computational cost and time are substantially reduced.

The 2D maps represent the distribution of these geohazards on the surface of the seabed (offshore environment) or on the land surface (onshore environment), providing information on the location and extent of each of them, for example, the slope of the seabed or the land surface. These maps can be created from geological mapping techniques, seismic data, well data, geotechnical data and other relevant sources of information. They provide an overview of the presence of geohazards and their characteristics on a spatial scale.

In addition to 2D maps, 3D maps representing the distribution of geohazards at depth can also be used. These maps provide more detailed information about the characteristics of the upper geological formations and how they interact with the reservoir, including regions with faults and igneous rocks, for example. They can be created based on data from seismic profiles, exploratory wells, advanced geotechnical data and geological modeling.

When it comes to geohazards represented by 2D maps, the method of the disclosure uses the x and y coordinates of the points at which the data were obtained for the spatial analysis of these risks. 2D maps provide a visual representation of the distribution of geohazards, generally in the form of an image or data matrix. To use them as inputs in a flow simulator, the x and y coordinates are required, which indicate the relative position of each point in space. These x and y coordinates are used to describe the spatial distribution of the selected geohazard. For example, if we consider a 2D map that represents the slope of the seabed, the x and y coordinates will indicate the precise location of the points where the slope was measured. In this way, the method incorporates this data into the well trajectory optimization process.

Another important piece of data is the value of the property associated with the geohazard. Depending on the type of 2D map used, this value may vary. For example, if the 2D map represents the slope of the seabed, the value of the property may be the slope angle at each point. This information is essential for assessing the influence of the geohazard on the well trajectory and aiding in decision-making during the optimization process.

In the case of geohazards represented by 3D maps, the x, y, and z coordinates describe the exact position of the geohazard in three-dimensional space. In this case, the distribution of the geohazard is represented in a volume, where each point has three-dimensional coordinates that indicate its exact location. This information is particularly relevant for three-dimensional geohazards, such as geological faults. By using 3D maps that represent the distribution of these faults, the x, y and z coordinates are essential to map their extent and precise location in the reservoir.

By integrating the 2D and 3D maps representing the geohazards, this method makes it possible to consider their spatial influences in the process of defining the well path. This information allows the assessment of the presence of specific geological risks and makes informed decisions about the best route for the wells.

The optimization tool created works coupled with commercial reservoir flow simulators. The first step in the drainage network optimization process consists of reading and interpreting the field flow simulation model by the tool, that is, the tool must identify all the wells that are part of the field simulation model and, also, the geometry of the well paths in the reservoir. Then, the several 2D and 3D geohazard maps selected for the field under evaluation are loaded. An important point in this process is the definition of the risk ranges of the several geohazards represented on the maps, exemplified without limitation in FIG. 10. In this example, consider that for the geohazard related to the inclination of the seabed, the project team decided that angles less than 5 degrees represent an ideal condition with low risk. If the angle is between 5 and 10 degrees, this solution is accepted, but there will be a penalty in the calculation of the NPV of the well in question. Angles above 10 degrees characterize a high-risk scenario, and the proposed solution is unacceptable. In this case, the drainage network under evaluation is discarded and another is proposed by the method. The same rationale is applied to evaluate the risk of the distance between the well trajectory and the mapped faults, both inside and outside the reservoir. The team of geoscientists in charge of the field development plan, made up of geophysicists, geologists and engineers from different areas, such as reservoirs, wells and elevation and flow, defines the tolerance ranges for geohazards that will be classified as low, medium and high risk.

For example, considering purely illustrative and non-limiting values, in relation to the inclination of the seabed at the location where the wellhead will be installed, the risk will be low if this angle is less than 5 degrees, if the angle is greater than 5 degrees and less than 10 degrees the risk will be medium and, for angles above 10 degrees the risk will be high. In the case of geohazards related to geological faults within or above the reservoir, the aim is, for example and without limitation, for the trajectory of the wells to have a minimum distance of 200 meters in relation to the faults so that the low risk condition is obtained, if this distance is between 100 and 200 meters we have the medium risk condition and, below 100 meters, high risk.

During the drainage network optimization process, genetic algorithms are used to propose several solutions for the drainage network, i.e., the developed method allows the creation of solution proposals in which cases are simulated wherein the number of wells, the location of each well, and the length of the well section open to the flow in the reservoir vary. Then, considering the set of defined geohazards, the trajectory of each well is constructed, from the open section in the reservoir to the wellhead, seeking to minimize the drilling risk of each trajectory. A premise of the developed methodology is not to accept a solution in which the trajectory of any well is in a high-risk condition for any geohazard. If this occurs, this solution is not accepted and is discarded. Ideally, the most interesting scenario would be one in which the trajectory of all wells has low risk for all geohazards analyzed. However, such a scenario may not be viable, since the optimization process seeks, in addition to reducing risks, also to maximize the economic return of the project. Thus, solutions with medium risks are also accepted, but, unlike the treatment given to low-risk solutions, medium-risk solutions are penalized. This penalty quantifies how far the medium-risk parameters deviate from the value determined for the low-risk condition. Alternatively, a geological risk threshold can be predefined and solutions in which the geological risk is greater than the geological risk threshold can be discarded, and new solutions are simulated. Additionally, solutions in which a predefined economic return is not achieved can be discarded and new solutions are simulated.

For example, considering that for a specific well the seabed slope at the location where the wellhead is to be positioned has an angle of 7 degrees. The low-risk condition considers angles below 5 degrees and the high-risk condition occurs for angles above 10 degrees. In this case, the 7-degree angle represents a deviation of 40% in relation to the low-risk condition. Due to this deviation, the economic return of this well is reduced by 40%. This ensures that solutions in which all wells are in low-risk condition and only one well is in medium-risk condition are preserved and kept suitable for the optimization process.

Therefore, the x and y coordinates of the 2D maps or the x, y and z coordinates of the 3D maps allow the spatial distribution of the selected geohazards to be incorporated and used as input data to perform the risk analysis and optimization of the well trajectory. This approach improves the ability to consider the effects of geohazards during the planning process and maximizes the safety and efficiency of oil and gas exploration and production operations.

By replacing the upper formations with representative geohazard maps, it is possible to significantly reduce the number of cells to be simulated. Therefore, it becomes unnecessary to include in the flow simulation model, in addition to the reservoir, the formations above the reservoir. In other words, instead of discretizing and simulating each cell in all layers of the upper formations, the flow simulation model representative of only the reservoir cells is used.

This approach has several advantages. First, it considerably reduces the computational cost, since the total number of simulated cells is significantly smaller. This allows the simulations to be performed in a reduced time and with more accessible computational resources. In addition, it simplifies the simulation model, making it easier to build, calibrate and update as new information about geohazards becomes available.

However, it is important to take some precautions. Replacing the upper geological formations with maps can result in a loss of detail and resolution. The interactions between the upper formations and the reservoir may not be fully captured, resulting in an overly simplified representation. Therefore, special care is required when interpreting and applying the results of simulations based on this strategy.

In addition, the reliability and quality of the maps used are essential. Reliable, up-to-date and comprehensive geological data are crucial to accurately map geohazards. This includes the collection of high-resolution seismic data, well samples, geotechnical analyses and detailed geological modeling. The lack of adequate information can lead to an inaccurate representation of geohazards and compromise the effectiveness of the strategy.

Therefore, the strategy of replacing the upper geological formations in a flow simulation model with a set of maps representative of the mapped geohazards is a valid approach to substantially reduce the computational cost and make this type of study viable, since, as shown above, the numerical modeling of the reservoir and the upper formations has a high computational cost that makes it impractical for most cases. The approach developed in the present disclosure simplifies the simulation model, using 2D and/or 3D maps to incorporate the influences of geohazards in the simulations.

Unlike the traditional drainage network optimization method, which considers only the reservoir simulation model and disregards the geohazard information of the formations above the reservoir, the method of the present disclosure allows the use of an unlimited number of 2D and 3D maps representative of geohazards. The method of the present disclosure also optimizes the trajectory of the wells, from the reservoir to the wellhead, aiming to reconcile the maximization of the net present value and the minimization of the risks inherent to the existence of geohazards.

By incorporating geohazard maps into the optimization process, the present disclosure allows a more comprehensive analysis of the risks involved in the construction and trajectory of the wells. The present disclosure evaluates not only the production efficiency and economic return, but also the operational safety and the mitigation of geological risks. In this way, it is possible to make more informed and strategic decisions in the definition of the drainage network, seeking a balance between the maximization of the net present value and the minimization of geological risks.

The optimization of the trajectory of the wells is also a crucial aspect of this approach. By considering the trajectory from the reservoir to the wellhead, it is possible to take into account the geohazards along the way and adjust the route of the wells in order to minimize the associated risks. This involves the analysis of geotechnical information, seismic data, characteristics of the reservoir and upper formations, among other relevant factors. The computer-implemented method of the present disclosure uses genetic algorithms to explore different well locations in the reservoir and an algorithm that seeks to find the well path that mitigates the mapped geological risks and shows the smallest distance from the wellhead in relation to the section open to flow in the reservoir.

The process of optimizing the well path is a fundamental step in the search for an efficient and safe drainage network in the exploration of oil and gas reservoirs. In order to maximize efficiency and minimize drilling costs, it is necessary to find the best position for the wellhead, starting from the optimal position in the reservoir.

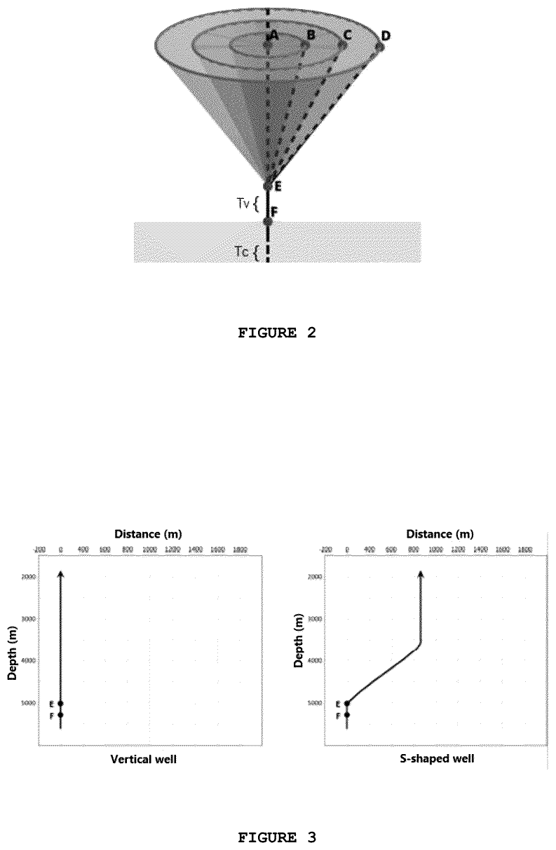

The well trajectory optimization process is schematically shown in FIG. 2. Starting from the perforated well section Tc (open to flow) in the reservoir, there is point F, which indicates the top of the reservoir and the beginning of the upper formations. The section from point F to point E is known as the verticalization section Tv, where the well trajectory is vertical. Ideally, the well trajectory would be drilled vertically between point E and point A, which is the wellhead. This approach is preferred, since drilling a vertical well generally has a lower cost compared to non-vertical configurations. The vertical trajectory is considered the ideal option, as it minimizes efforts and deviations during drilling. If the vertical trajectory is impossible to be constructed due to the violation of some high-risk condition of one of the mapped geohazards, for example, in some section the distance from the well to one of the mapped faults is less than the minimum acceptable and is, therefore, in the high-risk condition. In this condition, new simulations are performed in which the position of the wellhead is moved by a distance defined by the user, for example and without limitation, 100 meters, to the least preferred point B. Point B represented in FIG. 2 is merely illustrative, since the method of the disclosure evaluates all cells that are up to 100 meters away from point A, following a circumference centered on point A, as possible positions for the wellhead until one with the lowest geological risk is selected. If no position is accepted, that is, none of the simulated cells with distance B from point A results in a trajectory with geological risk lower than the predetermined threshold, the search radius is expanded again to distance C and, if this is still impossible, to distance D. Distance D is, in this example, considered as the maximum horizontal distance of the wellhead, or the maximum angle of inclination of the well previously defined by the user. If no trajectory from point D results in a geological risk below the predetermined threshold, the well position F in the reservoir is discarded and a new one is generated. This approach ensures comprehensive exploration of the possible positions, taking into account all viable directions and ranges.

Obviously, alternative distances B, C and D are merely illustrative and do not limit the disclosure. Any number of alternative distances can be used without departing from the scope of the disclosure. Obviously, the greater the number of alternative distances considered, the greater the tendency for the processing time to increase, requiring greater processing capacity.

The well trajectory optimization process is iterative and carried out systematically, exploring all possibilities within the limits established for the maximum distance from the wellhead. It allows finding the best position for the wellhead, considering the restrictions imposed by the geohazards of the 2D and/or 3D maps used, seeking to maximize drilling efficiency. It is also important to highlight that the well trajectory optimization process is extremely efficient, since it does not require flow model simulations. Compared to the computational cost of flow simulation, the computational cost of trajectory optimization is practically negligible, since it only involves trigonometric calculations and risk assessment.

By incorporating this optimization approach into the definition of the drainage network, it is possible to reduce drilling costs, ensure operational safety and optimize oil and gas production. By searching for vertical trajectories and the best possible position, taking geohazards into account, it is possible to obtain an efficient drainage network that is aligned with operational and economic objectives.

Incorporating restrictions and limits related to the disciplines of geology and geophysics from the beginning of the well trajectory optimization process is a fundamental approach to minimize or even eliminate the need for rework. This strategy represents a great advantage and a differential of the method of the present disclosure, as it allows decisions to be made more accurately and assertively from the beginning of planning.

By considering restrictions and limits from the beginning, the method of the present disclosure takes into account the geological and geophysical knowledge of the reservoir and adjacent formations, allowing reservoir engineers to make more informed and well-founded decisions. This prevents decisions from being made that need to be revised later, saving time, resources and avoiding rework.

Constraints and limits related to geology and geophysics can cover a wide range of factors. For example, they can include the presence of geological faults, fracture zones, reservoir heterogeneities, variations in permeability, among others. These elements have a direct impact on the ideal well trajectory, since drilling needs to take these characteristics into account to ensure production efficiency.

By incorporating these constraints and limits from the beginning of the optimization process, the method of the present disclosure considers the geometry and geological properties of the reservoir and upper formations in an integrated manner. This allows for more informed decisions to be made regarding the well trajectory, taking into account the complexity of the formations.

Furthermore, by considering the constraints imposed by geohazards from the beginning of the mesh generation process, the method of the present disclosure allows for the identification of potential problems before they occur. This avoids surprises during the drilling process and reduces the likelihood of encountering unexpected obstacles or geohazards that could compromise the safety and efficiency of the operation.

Another important advantage is the saving of financial resources. Rework in drilling projects can be extremely costly, involving not only the costs of the drilling itself, but also additional expenses resulting from delayed production and the need to implement corrective measures. By avoiding rework by incorporating constraints from the beginning, this method contributes to cost reduction and optimization of the project budget.

In addition, the approach of incorporating constraints from the beginning provides more comprehensive and integrated planning. By considering geological and geophysical factors from the beginning, it is possible to perform a more complete and detailed analysis of the reservoir and upper formations. This allows reservoir engineers to identify opportunities for optimizing the well path that can result in more efficient production and maximization of the net value of the project.

Additionally, the method of the present disclosure includes a step of providing a set of tables, figures and maps that help the designer to analyze the result of the optimization process and evaluate the effectiveness of the drainage network optimization method considering geohazards. FIG. 3 graphically shows the trajectory of the wells, from the reservoir (point F) to the position of the wellhead (point A to D). On the left side of FIG. 3, a producing well is represented that has a vertical trajectory, that is, the horizontal displacement of the wellhead in relation to the position of the well in the reservoir is zero. On the right side of FIG. 3, a S-shaped well was used to deal with the mapped geohazards. In this case, the wellhead was displaced around 800 m in relation to the position of the well in the reservoir.

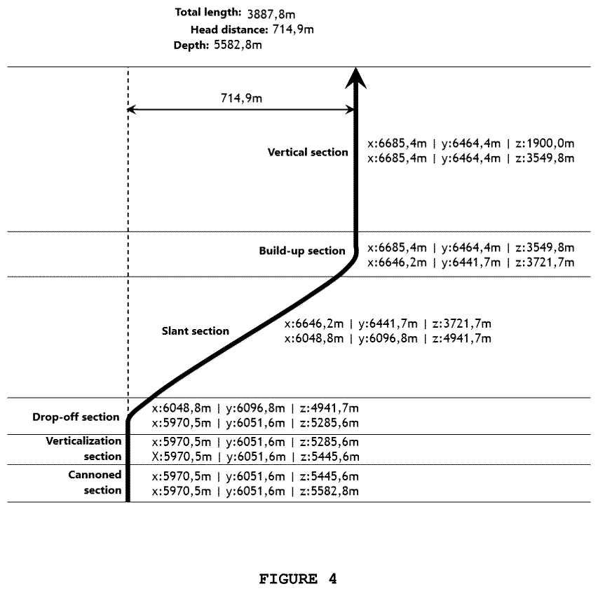

In the case of a S-shaped well, the method can provide all the construction data of the well trajectory, for each of the sections, from the beginning of the well to the end in the reservoir, exemplified in FIG. 4, in which the coordinates and lengths mentioned are merely illustrative. All this information can be inserted by geoscientists into specific tools for the analysis of seismic data or geological sections to evaluate in detail the interaction of the well with the crossed formations. An important point to highlight is that the flow simulation models are built with cells on a vertical scale of meters, while the geological data are described on a scale of centimeters. This type of evaluation can be understood as an additional verification that the trajectory of the wells proposed by the method of the present disclosure fully meets all the mapped geohazards.

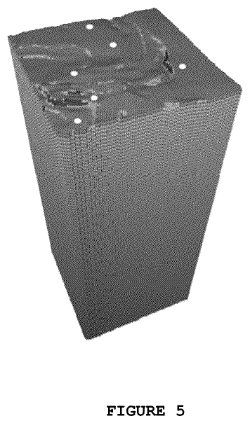

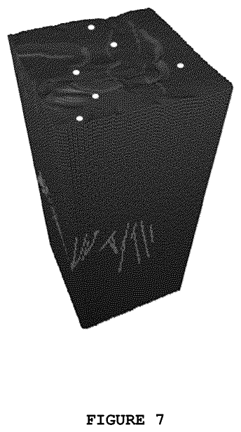

As shown in FIG. 5 and FIG. 7, the method of the present disclosure optionally provides for showing to the user a graphical representation of the trajectory of the wells in relation to each of the geohazards inserted in the optimization process through 2D and 3D maps. The generated maps identify, for each geohazard, the low, medium and high-risk regions through a color scale. The designer can then manipulate these maps (using, for example, specific software) to observe in detail some region previously identified as problematic for drilling, for example.

FIG. 5 exemplifies how the flow simulator interprets the addition of data related to a 2D geohazard. In this specific case, the distribution map of the seabed inclination angle is shown. FIG. 5 is represented in 3D format to make it clear that, although the set of geological formations extends from the seabed to depths below the reservoir, this specific type of geohazard is located only on the surface of this three-dimensional object. The green regions represent risk for the wellhead location (indicated by the white circles). The yellow regions indicate medium risk regions, and the red regions indicate high risk.

FIG. 7 illustrates how the flow simulator interprets the addition of data related to a 3D geohazard. In this specific case, the distribution map of geological faults above the reservoir (red faults) and inside the reservoir (yellow faults) is shown. FIG. 7 is represented in 3D format to make it clear that geological faults can extend from the seabed to depths below the reservoir. This specific type of geohazard is represented in the reservoir in a three-dimensional format. The position of the wellhead is indicated by the white dots.

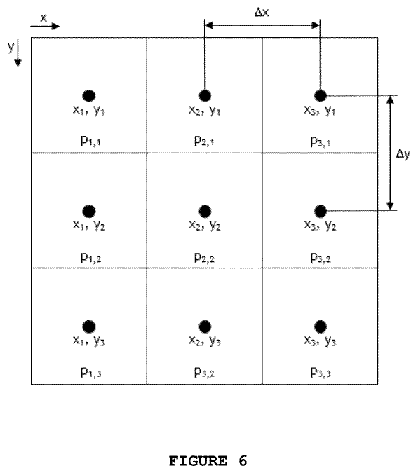

FIG. 6 represents the mapping of the 2D geohazard data. FIG. 6 indicates that the data were obtained with spacing Δx in the x direction and Δy in the y direction. The points xi, yi represent the sampled points. These values are interpreted as representing a region with dimensions Δx×Δy, in which pi,j indicates the property value in cell i,j. The same approach is used for cases in which the spacing between points in the x and y directions is not uniform.

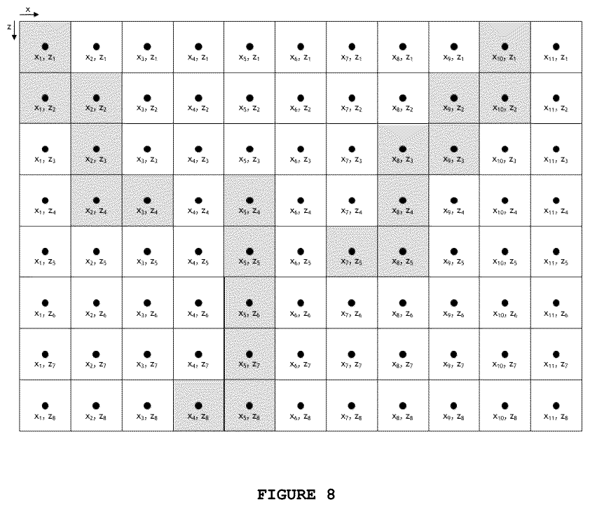

FIG. 8 represents the mapping of geohazard data related to faults in the reservoir and/or in the upper formations. A vertical xz section is considered, with spacing Δx in the x direction and Δz in the z direction. Points xi, zi represent the midpoints of the mapped cells. For illustrative purposes only, it is assumed that Δx=Δz. Cells crossed, at any point, by faults are indicated in gray. The same approach is used for cases in which the spacing between points in the x and z directions is not uniform and/or Δx≠Δz.

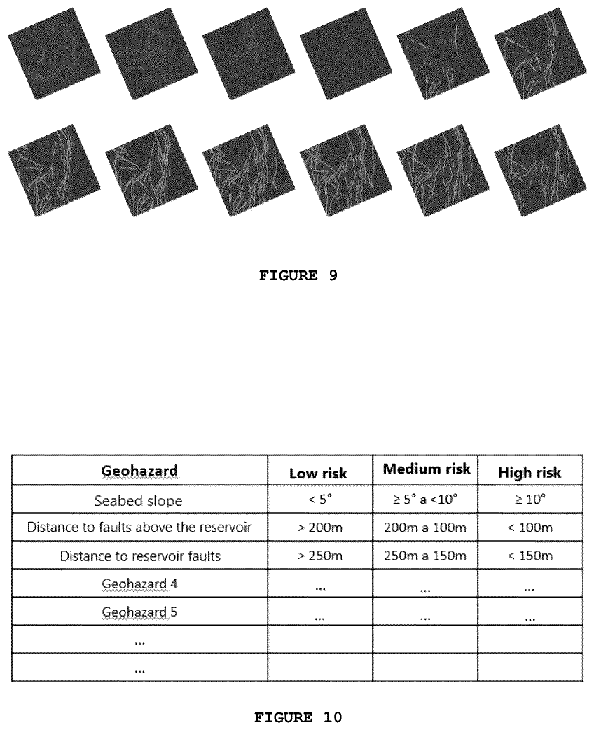

Finally, FIG. 9 represents horizontal sections of the model from the wellhead to the lower region of the reservoir, indicating the vertical variation in the distribution and density of faults. It can be seen that the upper geological faults are fewer and have lower density (red) when compared to the faults mapped in the reservoir (yellow). The higher density of faults in the reservoir implies greater difficulty in finding low-risk well trajectories, while in the upper geological formations, due to the lower number and density of faults (red), it is estimated that there will be less difficulty in optimizing low-risk trajectories.

The graphic representations illustrated in FIGS. 3, 5 and 7 can be generated by incorporated or separate commercial software. The details of the generation of such graphic representations are not the focus of the present disclosure and will not be detailed.

The present disclosure may be used for optimizing the trajectory of subsea or onshore wells without limitation, provided that the operator of the flow simulator makes the necessary adjustments to the flow simulator considering the practical application.

Although aspects of the present disclosure may be susceptible to various modifications and alternative forms, specific embodiments have been shown by way of example in the drawings and have been described in detail herein. But it should be understood that the disclosure is not intended to be limited to the particular forms disclosed. Rather, the disclosure is intended to cover all modifications, equivalents, and alternatives that fall within the scope of the disclosure as defined by the following appended claims.

1. A computer-implemented method for optimizing oil field drainage networks, the method comprising the steps of:
a) inserting data obtained from 2D and/or 3D maps representative of geohazards that are located above a reservoir into a well trajectory simulator and simulating the wells in the drainage network;
b) for each well simulated in the drainage network, defining an entry point (F) into the reservoir, a perforated section (Tc) and a vertical section (Tv), and an optimal wellhead point (A);
c) simulating the trajectory of each well from point F to the optimal point (A) based on the data from the 2D and/or 3D maps and obtaining a geological risk for each well trajectory;
d) for each well simulated in the drainage network, if the geological risk obtained in step c is less than or equal to a predefined threshold, selecting the well trajectory for this well;
e) for each simulated well in the drainage network, if the geological risk obtained in step d is greater than a predetermined threshold, obtaining one or more new wellhead points (B, C, D) and obtaining the geological risk of each of the trajectories thus simulated;
f) for each simulated well in the drainage network, if one or more trajectories obtained in step e have a geological risk lower than the predefined threshold, selecting the trajectory obtained with the lowest geological risk;
g) for each simulated well in the drainage network, if all trajectories obtained in step e have a geological risk higher than the predefined threshold, repeating steps e and f until a trajectory with a geological risk lower than the predefined geological risk is obtained or until a limit of new wellhead points is reached;
h) for each simulated well in the drainage network, if a trajectory with a geological risk lower than the predefined geological risk is obtained in step g, defining this trajectory as the well trajectory;
i) if a limit of new wellhead points is reached in any of the wells, returning to step b defining a new entry point (F) into the reservoir, a new perforated section (Tc) and a new vertical section (Tv), and a new wellhead point (A) for each well simulated in the drainage network.

2. The method according to claim 1, wherein the new wellhead points are obtained by applying a predefined horizontal distance to point A or by performing a predefined inclination in the well trajectory, and wherein the limit of new wellhead points is reached when a predefined maximum horizontal distance or a predefined maximum inclination angle is reached.

3. The method according to claim 1, further comprising, if the well trajectory is defined, indicating to the user graphical representations of one or more of the well trajectory, well trajectory data, or graphical representations of the geohazards represented by the 2D and/or 3D maps.

4. The method according to claim 1, wherein:
step c further comprises obtaining an estimated economic return;
step d further comprises selecting the well trajectory only if, in addition, the estimated economic return is greater than or equal to a predefined economic return;
step e further comprises obtaining one or more new wellhead points if the estimated economic return is less than the predefined economic return and additionally obtaining the estimated economic return of each of the trajectories thus simulated;
step f further comprises selecting the well trajectory only if, in addition, the estimated economic return is greater than or equal to the predefined economic return;
step g further comprises repeating steps e and f if, additionally or alternatively, all trajectories obtained in step e have an estimated economic return lower than the predefined economic return and repeating until a trajectory is obtained wherein the estimated economic return is additionally greater than or equal to the predefined economic return or until a limit of new wellhead points is reached;
step h further comprises defining the trajectory obtained in step g as the trajectory of the well if it additionally has an estimated economic return greater than or equal to the predefined economic return.

5. The method according to claim 4, wherein the wells are simulated by means of a genetic algorithm.
